(19) United States
(12) Patent Application Publication
(10) Pub. No.: US 2025/0328965 A1
(43) Pub. Date: Oct. 23, 2025

(54) SYSTEMS AND METHODS FOR GENERATING A SOCIAL GRAPH BASED ON USER PHONE CONTACTS

(71) Applicant: Dastronics Technology, LLC, Kyle, TX (US)

(72) Inventors: Sunday Ayanleke David, Kyle, TX (US); Pelumi Boluwatife David, Kyle, TX (US); Kayode Jonathan Ajala, Kyle, TX (US)

(73) Assignee: Dastronics Technology ,LLC, Kyle, TX (US)

(21) Appl. No.: 18/642,916

(22) Filed: Apr. 23, 2024

(51) Int. Cl. G06Q 50/00; H04M 1/27457

(52) U.S. Cl. CPC G06Q 50/01; H04M 1/27457

(57) ABSTRACT

Computer-implemented systems and methods for generating a social graph based on user phone contacts are described.

### FIELD

Some implementations are generally related to computerized social graph systems and, more particularly, related to systems and methods for generating a social graph based on user phone contacts.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a flowchart of an example method of generating a social graph based on user phone contacts and matching user via the graph in accordance with some implementations.

FIG. 3 is a diagram of an example social graph based on phone contacts in accordance with some implementations.

FIG. 4 is a diagram of an example graphical user interface for systems and methods

for generating a social graph based on user phone contacts in accordance with some implementations.

FIG. 5 is a block diagram of an example computing device which may be used for one or more implementations described herein.

### DETAILED DESCRIPTION

Some implementations include methods and systems for generating a social graph based on user phone contacts and matching users via the graph.

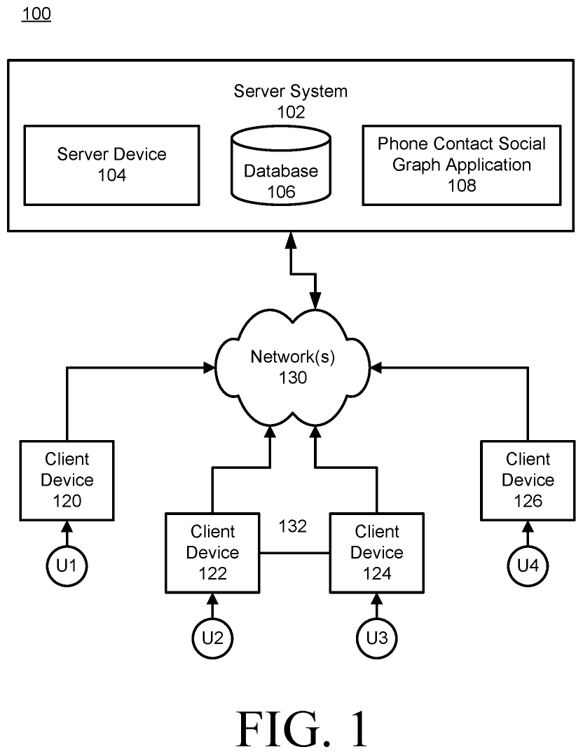

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and a phone contact social graph application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide phone contact social graph functions as described herein.

Various implementations of features described herein can use any type of system and/or service. Any type of electronic device can make use of the features described herein. Some implementations can provide one or more features described herein on client or server devices disconnected from or intermittently connected to computer networks.

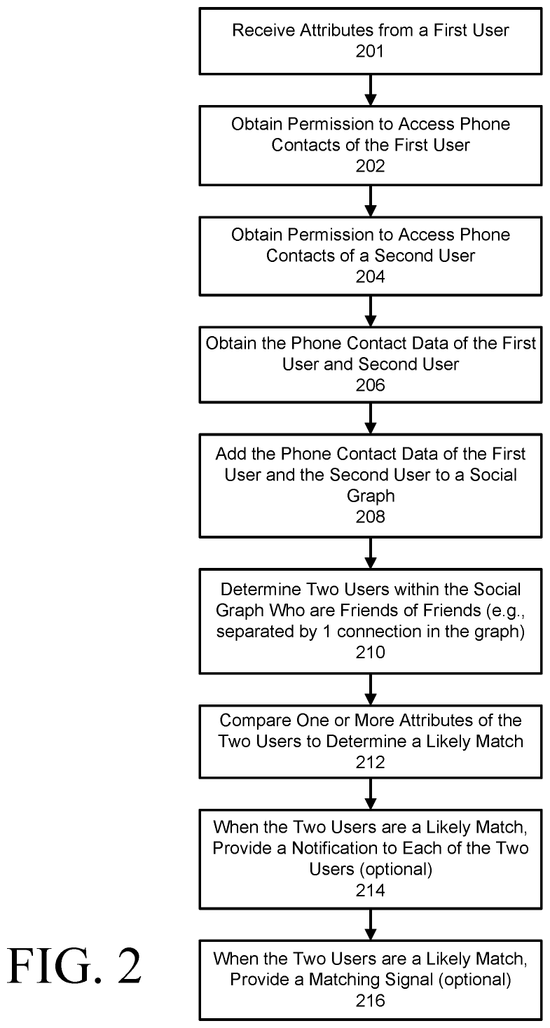

FIG. 2 is a flowchart of an example method of generating a social graph based on user phone contacts in accordance with some implementations. Processing begins at 201, where one or more attributes are receives from a first user. For example, during a registration or sign-up process, the first user may provide the one or more attributes. The attributes can be attributes that help a computerized matching system (e.g., a dating application, or the like) match users. The attributes can include one or more demographic information, social information, hobby information, education information, and vocation information, or the like. In general, any attributes that could be used to match users can be included in attribute information. Processing continues to 202.

At 202, the system (e.g., mobile application) obtains permission to access the phone contacts of the first user. For example, the first user may give permission for the system to access phone contacts within a device associated with the user (e.g., a smartphone). In addition to the phone contacts, the system can obtain permission to access the phone number of the first user. Processing continues to 204.

At 204, the system (e.g., mobile application) obtains permission to access the phone contacts of the second user. For example, the second user may give permission for the system to access phone contacts within a device associated with the user (e.g., a smartphone). In addition to the phone contacts, the system can obtain permission to access the phone number of the second user. Processing continues to 206.

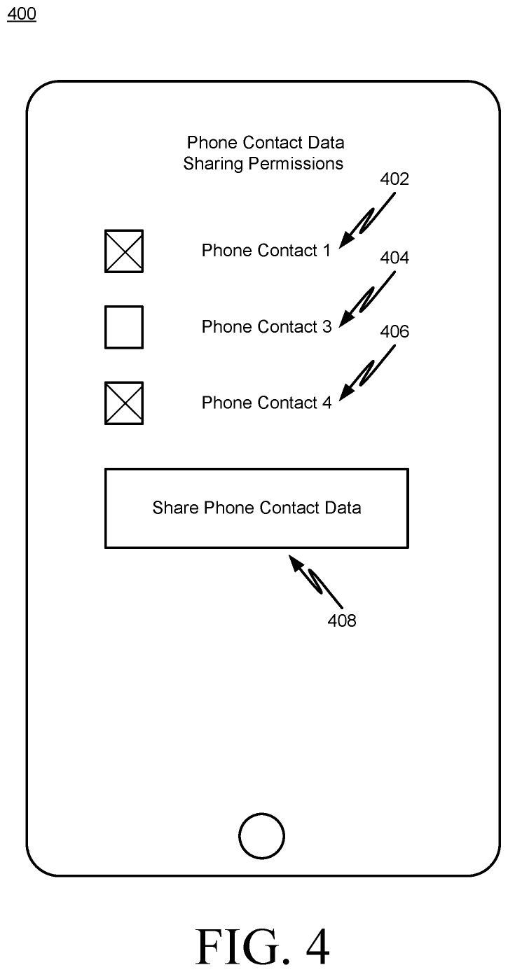

At 206, the system obtains the phone contact data of the first and second user. For example, the system, via mobile application, can obtain the phone contacts of the mobile devices associated with the first user and the second user. The phone contacts can include phone numbers and other data such as name, mailing address, email address, or the like. In some implementations, users are permitted to select contacts to not add to the social graph. For example, the contacts can be selected for omission via user interface such as that shown in FIG. 4. For contacts that have the phone contact social graph app installed, there will be attribute data available. For those contacts that do not have the app installed, they will be traversal nodes in the social graph. Also, in some implementations, users are permitted to select contacts or users that they do not wish to be visible to or matched with. Processing continues to 208.

At 208, the phone contact data of the first user and the second user is added to a phone contact social graph. The phone numbers can optionally be encoded. Processing continues to 210.

At 210, the system determines that two users are friends of friends or are within a given number of nodes from each other in the social graph. For example, friends of friends would be separated by one node. In some implementations, a selectable number of nodes separating connections can be provided such that a match can be made from two users who are within the selected number or less of nodes separating the users. In some implementations, users can be matched with their own contacts. For example, this may permit a user to reconnect with a long-lost friend or acquaintance. Processing continues to 212.

At 212, once the first user and a second user are matched based on phone contact node distance, attributes of the first user and the second user are compared. The first user and the second user are a “match” when one or more attributes of each user are within a threshold amount of difference from each other. Processing continues to 214.

At 214, when the first user and the second user are a match, a notification can optionally be provided to each user. In some implementations, the notification can include one or more of the degrees of separation of the two users in the phone contact social graph and may also include the names of the user separating the two users. Processing continues to 216.

At 216, when the first user and the second user are a match, a match signal can be provided to another system (either integrated with the social graph or an external system).

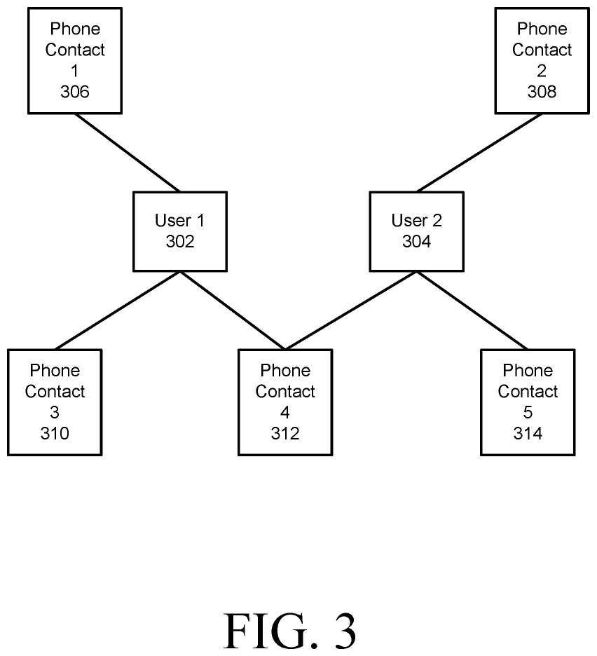

FIG. 3 is a diagram of an example social graph based on phone contacts in accordance with some implementations. In particular, a first user 302 has 1-degree contacts including Phone Contact 1 306, Phone Contact 3 310, and Phone Contact 4 312. A second user 304 has 1 degree contacts Phone Contact 2 308, Phone Contact 4 312 and Phone Contact 5 314. The first user 302 and the second user 304 have a single contact in common, namely Phone Contact 4 312.

Phone contact 3 310 and Phone Contact 4 312 are second degree friends of friends—i.e., they have a mutual friend, User 1 302. A third-degree separation exists between Phone Contact 3 310 and User 2 304, and a fourth-degree separation exists between Phone Contact 3 310 and the Phone Contact 5 314.

FIG. 4 is a diagram of an example graphical user interface 400 for systems and methods for generating a social graph based on user phone contacts in accordance with some implementations. The interface 400 includes a plurality of phone contacts 402-406 and an element to submit the contact data 408.

Further, the interface includes elements to include or exclude a contact from the social graph. For example, phone contact 3 has a checkbox that has been unchecked so that this contact will not be included.

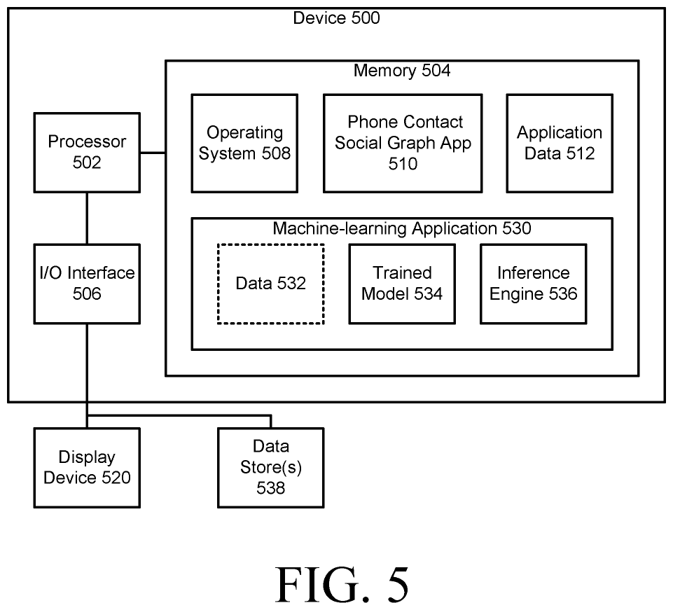

FIG. 5 is a block diagram of an example device 500 which may be used to implement one or more features described herein. In one example, device 500 may be used to implement a client device, e.g., any of client devices 120-126 shown in FIG. 1. Alternatively, device 500 can implement a server device, e.g., server device 104, etc. In some implementations, device 500 may be used to implement a client device, a server device, or a combination of the above. Device 500 can be any suitable computer system, server, or other electronic or hardware device as described above.

One or more methods described herein (e.g., the method of FIG. 2) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 500 includes a processor 502, a memory 504, and I/O interface 506. Processor 502 can be one or more processors and/or processing circuits to execute program code and control basic operations of the device 500. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 502 may include one or more co-processors that implement neural-network processing. In some implementations, processor 502 may be a processor that processes data to produce probabilistic output, e.g., the output produced by processor 502 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is typically provided in device 500 for access by the processor 502, and may be any suitable processor-readable storage medium, such as random access memory (RAM), read-only memory (ROM), Electrically Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 508, machine-learning application 530, phone contact social graph application 510, and application data 512. Other applications may include applications such as a data display engine, web hosting engine, image display engine, notification engine, social networking engine, etc. In some implementations, the machine-learning application 530 (e.g., Graph Neural Network or the like) and phone contact social graph application 510 can each include instructions that enable processor 502 to perform functions described herein, e.g., some or all of the methods of FIG. 2.

The machine-learning application 530 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a phone contact social graph application 510 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 530 may utilize Bayesian classifiers, support vector machines, neural networks, or other learning techniques. In some implementations, machine-learning application 530 may include a trained model 534, an inference engine 536, and data 532. In some implementations, data 432 may include training data, e.g., data used to generate trained model 534. For example, training data may include any type of data suitable for training a model for phone contact social graph tasks, such as images, labels, thresholds, etc. associated with a phone contact social graph described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 534, training data may include such user data. In implementations where users permit use of their respective user data, data 532 may include permitted data.

In some implementations, data 532 may include collected data such as phone contacts and matches. In some implementations, training data may include synthetic data generated for the purpose of training, such as data that is not based on user input or activity in the context that is being trained, e.g., data generated from simulated conversations, computer-generated images, etc. In some implementations, machine-learning application 530 excludes data 532. For example, in these implementations, the trained model 534 may be generated, e.g., on a different device, and be provided as part of machine-learning application 530. In various implementations, the trained model 534 may be provided as a data file that includes a model structure or form, and associated weights. Inference engine 536 may read the data file for trained model 534 and implement a neural network with node connectivity, layers, and weights based on the model structure or form specified in trained model 534.

Machine-learning application 530 also includes a trained model 534. In some implementations, the trained model 534 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 532 or application data 514. Such data can include, for example, images, e.g., when the trained model is used for phone contact social graph functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image is functional, etc. depending on the specific trained model. In some implementations, model form or structure also specifies a number and/or type of nodes in each layer.

In different implementations, the trained model 534 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 534 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 532, to produce a result.

For example, training may include applying supervised learning techniques. In supervised learning, the training data can include a plurality of inputs (e.g., a set of images) and a corresponding expected output for each input. Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner.

In another example, a model trained using unsupervised learning may cluster words based on the use of the words in data sources. In some implementations, unsupervised learning may be used to produce knowledge representations, e.g., that may be used by machine-learning application 530. In various implementations, a trained model includes a set of weights, or embeddings, corresponding to the model structure. In implementations where data 532 is omitted, machine-learning application 530 may include trained model 534 that is based on prior training, e.g., by a developer of the machine-learning application 530, by a third-party, etc. In some implementations, trained model 534 may include a set of weights that are fixed, e.g., downloaded from a server that provides the weights.

Machine-learning application 530 also includes an inference engine 536. Inference engine 536 is configured to apply the trained model 534 to data, such as application data 514, to provide an inference. In some implementations, inference engine 536 may include software code to be executed by processor 502. In some implementations, inference engine 536 may specify circuit configuration (e.g., for a programmable processor, for a field programmable gate array (FPGA), etc.) enabling processor 502 to apply the trained model. In some implementations, inference engine 536 may include software instructions, hardware instructions, or a combination. In some implementations, inference engine 536 may offer an application programming interface (API) that can be used by operating system 508 and/or phone contact social graph application 510 to invoke inference engine 536, e.g., to apply trained model 534 to application data 514 to generate an inference.

Machine-learning application 530 may provide several technical advantages. For example, when trained model 534 is generated based on unsupervised learning, trained model 534 can be applied by inference engine 536 to produce knowledge representations (e.g., numeric representations) from input data, e.g., application data 512. For example, a model trained for phone contact social graph tasks may produce predictions and confidences for given input information about possible matches. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 536.

In some implementations, knowledge representations generated by machine-learning application 530 may be provided to a different device that conducts further processing, e.g., over a network. In such implementations, providing the knowledge representations rather than the images may provide a technical benefit, e.g., enable faster data transmission with reduced cost. In another example, a model trained for functional image archiving may produce a functional image signal for one or more images being processed by the model.

In some implementations, machine-learning application 530 may be implemented in an offline manner. In these implementations, trained model 534 may be generated in a first stage and provided as part of machine-learning application 530. In some implementations, machine-learning application 530 may be implemented in an online manner. For example, in such implementations, an application that invokes machine-learning application 530 (e.g., operating system 508, one or more of phone contact social graph application 510 or other applications) may utilize an inference produced by machine-learning application 530, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 534, e.g., to update embeddings for trained model 534.

In some implementations, machine-learning application 530 may be implemented in a manner that can adapt to particular configuration of device 500 on which the machine-learning application 530 is executed. For example, machine-learning application 430 may determine a computational graph that utilizes available computational resources, e.g., processor 502. For example, if machine-learning application 530 is implemented as a distributed application on multiple devices, machine-learning application 530 may determine computations to be carried out on individual devices in a manner that optimizes computation. In another example, machine-learning application 530 may determine that processor 502 includes a GPU with a particular number of GPU cores (e.g., 1000) and implement the inference engine accordingly (e.g., as 1000 individual processes or threads).

In some implementations, machine-learning application 530 may implement an ensemble of trained models. For example, trained model 534 may include a plurality of trained models that are each applicable to same input data. In these implementations, machine-learning application 530 may choose a particular trained model, e.g., based on available computational resources, success rate with prior inferences, etc. In some implementations, machine-learning application 530 may execute inference engine 536 such that a plurality of trained models is applied. In these implementations, machine-learning application 530 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 508 or one or more other applications, e.g., phone contact social graph application 510.

In different implementations, machine-learning application 530 can produce different types of outputs. For example, machine-learning application 530 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 530 may produce an output video with a particular effect applied, e.g., rendered in a comic-book or particular artist's style, when trained model 534 is trained using training data from the comic book or particular artist, etc. In some implementations, machine-learning application 530 may produce an output based on a format specified by an invoking application, e.g. operating system 508 or one or more applications, e.g., phone contact social graph application 510. In some implementations, an invoking application may be another machine-learning application. For example, such configurations may be used in generative adversarial networks, where an invoking machine-learning application is trained using output from machine-learning application 530 and vice versa.

Any of software in memory 504 can alternatively be stored on any other suitable storage location or computer-readable medium. In addition, memory 504 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the server device 500 with other systems and devices. Interfaced devices can be included as part of the device 500 or can be separate and communicate with the device 500. For example, network communication devices, storage devices (e.g., memory and/or database 106), and input/output devices can communicate via I/O interface 506. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 506 can include one or more display devices 520 and one or more data stores 538 (as discussed above). The display devices 520 that can be used to display content, e.g., a user interface of an output application as described herein. Display device 520 can be connected to device 500 via local connections (e.g., display bus) and/or via networked connections and can be any suitable display device. Display device 520 can include any suitable display device such as an LCD, LED, or plasma display screen, CRT, television, monitor, touchscreen, 3-D display screen, or other visual display device. For example, display device 520 can be a flat display screen provided on a mobile device, multiple display screens provided in a goggles or headset device, or a monitor screen for a computer device.

The I/O interface 506 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 5 shows one block for each of processor 502, memory 504, I/O interface 506, and software blocks 508, 512, and 530. These blocks may represent one or more processors or processing circuitries, operating systems, memories, I/O interfaces, applications, and/or software modules. In other implementations, device 500 may not have all of the components shown and/or may have other elements including other types of elements instead of, or in addition to, those shown herein. While some components are described as performing blocks and operations as described in some implementations herein, any suitable component or combination of components of environment 100, device 500, similar systems, or any suitable processor or processors associated with such a system, may perform the blocks and operations described.

In some implementations, logistic regression can be used for personalization. In some implementations, the prediction model can be handcrafted including hand selected labels and thresholds. The mapping (or calibration) from ICA space to a predicted precision within a space can be performed using a piecewise linear model.

In some implementations, the phone contact social graph system could include a machine-learning model (as described herein) for tuning the system to potentially provide improved accuracy. Inputs to the machine learning model can include ICA labels, an image descriptor vector that describes appearance and includes semantic information about phone contact social graph. Example machine-learning model input can include labels for a simple implementation and can be augmented with descriptor vector features for a more advanced implementation. The output of the machine-learning module can include a prediction of likely matches within the phone contact social graph.

One or more methods described herein (e.g., the method of FIG. 2) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving, from a device associated with a first user, one or more attributes of the first user;
obtaining permission from the first user to access phone contacts of the first user within the device associated with the first user;
accessing the phone contacts of the first user;
adding the phone contacts of the first user to a phone contact social graph;
determining that the first user is within a given number of connections within the phone contact social graph to a second user;
comparing one or more attributes of the first user and the second user; and
when a match between attributes exists within a given threshold, performing a downstream action based on the match.

2. The method of claim 1, wherein the downstream action includes providing a notification of the match to the first user and the second user.

3. The method of claim 1, wherein the downstream action includes providing a match signal to another system.

4. The method of claim 1, wherein the one or more attributes include at least one of demographic information, social information, hobby information, education information, and vocation information.

5. The method of claim 1, further comprising encoding phone numbers within the phone contact social graph.

6. The method of claim 1, further comprising permitting the first user to select one or more phone contacts to not include in the phone contact social graph.

7. The method of claim 1, further comprising permitting the first user to select one or more user to block from matching the first user with.

8. The method of claim 1, wherein the given number of connections includes one node separating the first user and the second user within the phone contact social graph.

9. The method of claim 1, wherein the given number of connections includes a selectable number of nodes separating the first user and the second user within the phone contact social graph.
